(19) United States
(12) Patent Application Publication
(10) Pub. No.: US 2016/0303731 A1
(43) Pub. Date: Oct. 20, 2016

(54) Hand Tool and Retainer

(71) Applicant: James Edwin Barlow, Kasugai (JP)

(72) Inventor: James Edwin Barlow, Kasugai (JP)

(21) Appl. No.: 14/685,609

(22) Filed: Apr. 14, 2015

(51) Int. Cl. B25H 3/00

(52) U.S. Cl. CPC B25H 3/006

(57) ABSTRACT

A hand tool and retainer apparatus, in which a retainer holds a pair of handles of the hand tool in a storage position. The retainer is manually fitted to the hand tool when a user places the hand tool in a storage position. At least one of the handles includes a latch member for securing the retainer to the hand tool. The latch member includes a button portion, which is exposed through an opening in the retainer when the hand tool is retained in the storage position by the retainer. Manual depression of the button portion by the user in an inward direction of the hand tool allows the hand tool to be manually separated from the retainer.

### BACKGROUND

The present invention relates to hand tools and in particular, hand tools in which handles are retained in a storage position.

### SUMMARY

Basically, the invention is a hand tool and retainer apparatus. The apparatus includes a hand tool having a pivot joint and a pair of tool components that pivot about a pivot axis of the pivot joint. Each tool component has a distal end and a proximal end, and the pivot joint is located between the proximal end and the distal end of each tool component. Handles are located respectively at the proximal ends of the tool components. The apparatus further includes a retainer that retains the handles in a storage position. The retainer includes retention members that limit movement of the handles away from one another. The retainer is manually fitted to the hand tool when a user retains the hand tool in the storage position with the retainer. At least a first one of the handles includes a latch member for securing the retainer to the hand tool. The retainer includes a socket that receives the latch member when the retainer is fitted to the hand tool. The socket includes an engagement surface, which is formed by a surface of the socket in a location that corresponds to the latch member when the hand tool is retained in the storage position by the retainer. The latch member locks the hand tool to the retainer when the hand tool is retained in the storage position by the retainer. The latch member includes a button portion, which is an integral part of the latch member and is exposed through an opening in the socket when the hand tool is retained in the storage position by the retainer. A cam surface is formed by an interior surface of the socket, and the cam surface is positioned to engage the latch member and apply an inwardly directed force to the latch member to deflect the latch member in an inward direction of the hand tool when the retainer is being fitted to the hand tool. When the hand tool is retained in the storage position, the button portion is located such that manual depression of the button portion by the user in an inward direction of the hand tool causes the latch member to separate from the engagement surface, which allows the hand tool to be manually separated from the retainer from a distal end of the retainer. Separation of the hand tool from the retainer allows the handles to pivot away from one another.

In a further aspect, the latch member is attached to the first handle by a spring element so that the latch member is movable generally in inward and outward directions with respect to a central axis of the hand tool, and the latch member is biased by the spring element toward the engagement surface when the hand tool is retained in the storage position by the retainer.

In a further aspect, the retainer is a unitary member of which the retention members are integral parts.

In a further aspect, the cam surface is located generally at a distal end of the socket to engage the button portion and to guide the button portion to the opening when the retainer is fitted to the hand tool.

In a further aspect, the hand tool and the retainer are constructed as separate parts such that upon the separation of the retainer from the hand tool, the hand tool is free from the retainer when the hand tool is performing a tool function.

In a further aspect, an end opening is formed at the distal end of the socket, and the end opening is constructed to receive the first handle and the latch member when the retainer is fitted to the hand tool to retain the hand tool in the storage position.

In a further aspect, the latch member includes a hooking surface that is adapted to engage the engagement surface when the latch member secures the retainer to the hand tool, and wherein the hooking surface generally faces toward the end opening.

In a further aspect, the latch member and the spring element form a cantilever beam.

In a further aspect, the hand tool is a pair of scissors.

In a further aspect, the engagement surface is located on an edge of the opening.

In a further aspect, the latch member is a first latch member of a pair of opposite latch members on the hand tool, the engagement surface is a first engagement surface of a pair of opposite engagement surfaces on the retainer, and the opening is a first opening of a pair of opposite openings in the retainer.

In a further aspect, a pivot joint is formed by the retainer and a second one of the handles, so that the retainer is pivotal with respect to the hand tool.

In a further aspect, the handles have opposed abutment surfaces that limit the movement of the handles toward one another, and the abutment surfaces contact one another when the tool is retained in the storage position.

In a further aspect, at least sections of the retention members are inclined with respect to a longitudinal axis of the retainer such that a tapered space is defined between the retention members.

In a further aspect, the socket accommodates at least proximal ends of the handles when the hand tool is retained in the storage position.

In a further aspect, the socket houses a proximal portion of the hand tool and exposes a distal portion of the hand tool when the hand tool is retained in the storage position.

In a further aspect, a proximal section of the retainer includes a hangar tab, which includes an opening for receiving a support member.

In a further aspect, the retainer is a unitary plastic part.

In a further aspect, a spring device is connected to the tool components for applying spring forces to the tool components such that the handles are urged in opposite directions, away from one another, about the pivot axis.

In a further aspect, the latch member is biased toward the engagement surface at least by the spring device.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 is a front view of a hand tool and retainer apparatus according to a first embodiment;

FIG. 2 is a side view of the apparatus of FIG. 1;

FIG. 3 is a partial cross sectional view taken along plane 3-3 in FIG. 2;

FIG. 4 is a front view of the hand tool of FIGS. 1-3;

FIG. 5 is a cross sectional view of the retainer of the apparatus of FIGS. 1-3

FIG. 6 is a cross sectional view taken along plane 6-6 in FIG. 3;

FIG. 7 is a front view of a hand tool and retainer apparatus according to a second embodiment;

FIG. 8 is a side view of the apparatus of FIG. 7;

FIG. 9 is a partial cross sectional view taken along plane 9-9 in FIG. 8;

FIG. 10 is a partial cross sectional view of the apparatus of FIGS. 7-9;

FIG. 11 is a front view of a hand tool and retainer apparatus according to a third embodiment;

FIG. 12 is a side view of the apparatus of FIG. 11;

FIG. 13 is a partial cross sectional view taken along plane 13-13 in FIG. 12;

FIG. 14 is an exploded front view, partially in cross section, of the apparatus in FIGS. 11-13; and

FIG. 15 is a cross sectional view taken along plane 15-15 in FIG. 13;

FIG. 16 is a front view of a hand tool and retainer apparatus according to a fourth embodiment;

FIG. 17 is a partial cross sectional view of the apparatus of FIG. 16;

FIG. 18 is a partial cross sectional view of the apparatus of FIG. 16 showing depression of the button portions; and

FIG. 19 is a partial cross sectional view of the apparatus of FIG. 16 showing the hand tool being inserted into the retainer.

### DETAILED DESCRIPTION OF THE PREFERRED EMBODIMENTS

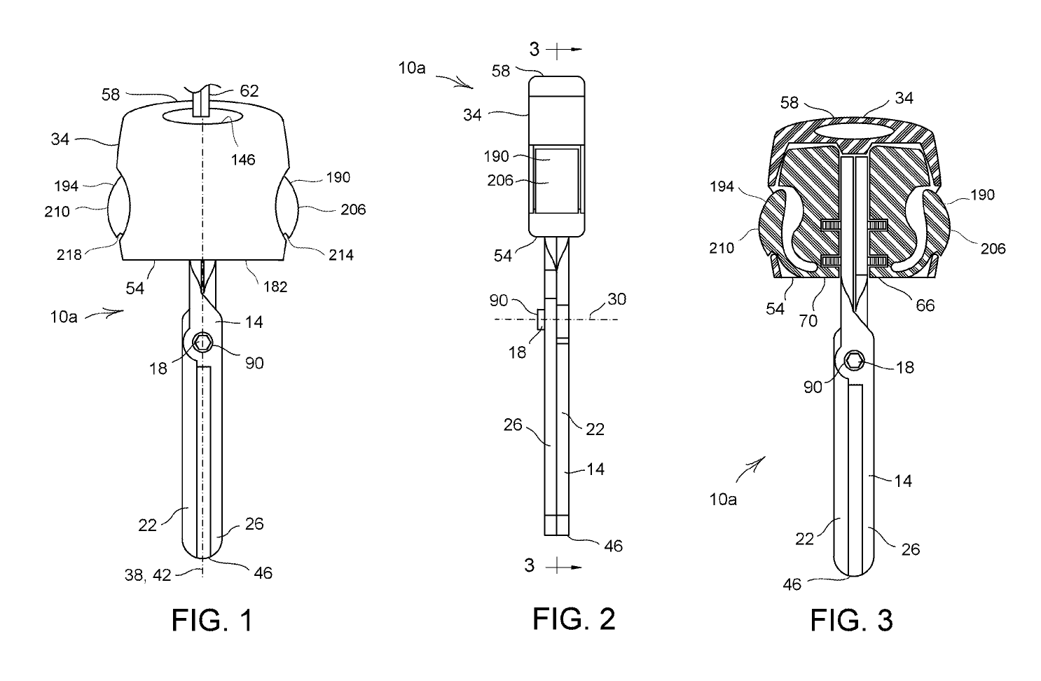

FIG. 1 shows a hand tool and retainer apparatus 10a in a storage position. The apparatus includes a hand tool 14 having a pivot joint 18 and a pair of tool components 22, 26 that pivot about a pivot axis 30 of the pivot joint 18. The apparatus 10a further includes a retainer 34, which is manually fitted to the hand tool 14 when a user retains the hand tool 14 in the storage position.

For reference purposes, the hand tool 14 includes a central longitudinal axis 38, and the retainer 34 includes a central longitudinal axis 42, and the central longitudinal axes 38, 42 are substantially coincident in the storage position of FIG. 1. The hand tool 14 has a distal end 46 and a proximal end 50, and the retainer 34 has a distal end 54 and a proximal end 58. The term “inward” refers to a direction generally toward one of the central longitudinal axes and the term “outward” refers to a direction generally away from one of the central longitudinal axes 38, 42.

The hand tool 14 is preferably a miniature hand tool. The distal end of the hand tool 46 is preferably shaped and sized like the distal part of a conventional automobile key, and the retainer 34 is preferably shaped and sized like a proximal part, or head portion, of a conventional automobile key. The apparatus 10a is adapted to be carried on a key ring 62.

The pivot joint 18 is located between the proximal end 50 and the distal end 54 of each tool component 22, 26. Handles 66, 70 are located respectively at the proximal ends of the tool components 22, 26. In the illustrated embodiments, the hand tool 14 is a pair of scissors. However, the hand tool 14 can be a pair of pliers, wire cutters or the like. The tool components 22, 26 are preferably made of stainless steel. In the embodiments of FIGS. 1-10, proximal ends of the tool components 22, 26 are fastened to the handles 66, 70 by, for example, threaded screws, as shown in FIG. 3. However, the proximal ends of the tool components 22, 26 can be fastened to the handles 66, 70 by injection molding the handles 66, 70 to the tool components 22, 26, by press-fitting, by adhesive or another known fastening method. The handles 66, 70 are preferably formed by plastic. For example, the handles 66, 70 can be molded from a strong, resilient, synthetic resin material such as, an aliphatic polyamide, polyoxymethylene, polypropylene, polybutylene terephthalate, or the like.

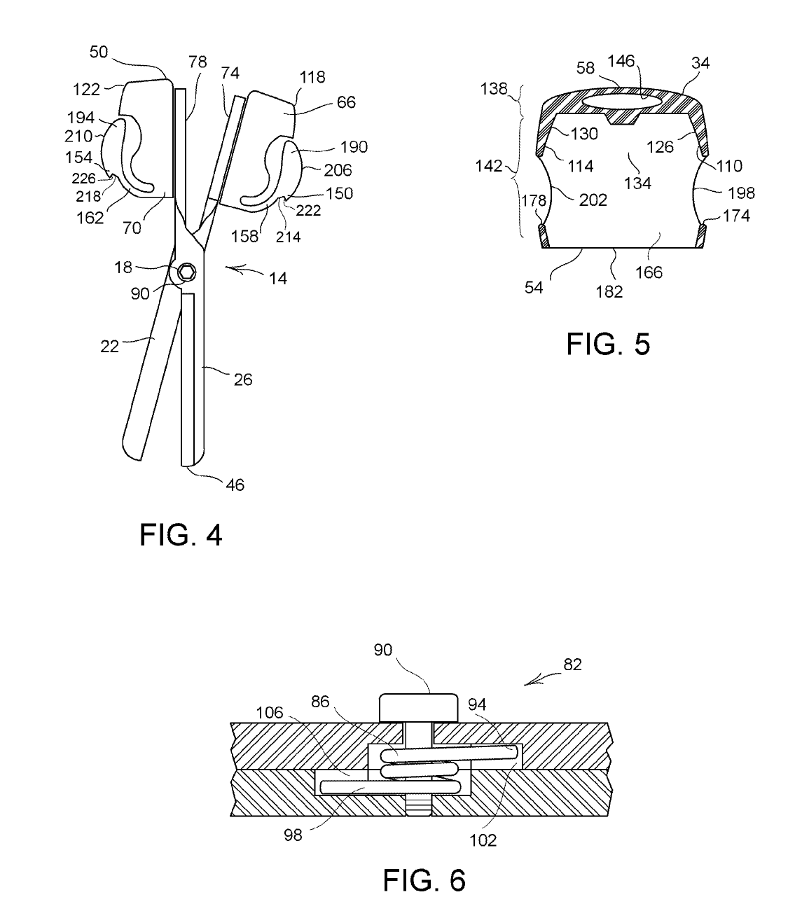

Opposed surfaces of the handles 66, 70 (See FIG. 4) form abutment surfaces 74, 78 that can contact one another to limit movement of the handles 66, 70 toward one another. Although FIG. 3 shows a slight gap between the handles 66, 70 when the hand tool 14 is in the storage position, the abutment surfaces 74, 78 can be in contact in the storage position, depending on the manufacturing tolerances of the parts. The handles are described in more detail below.

Miniature hand tools are typically biased to an open position because the handles are too small to accommodate finger openings that would allow the user to easily open the tool by finger movement. Since the hand tool 14 of FIGS. 1-6 may be too small to include finger openings, the handles 66, 70 can be spring-biased into an open position. For this purpose, the apparatus 10a can further include a spring device 82 connected to the tool components 22, 26 for applying spring forces to the tool components 22, 26 such that the handles 66, 70 are urged in opposite directions, away from one another, about the pivot axis 30. For example, FIG. 6 shows a spring device 82 that applies spring forces to the tool components 22, 26.

Referring to FIG. 6, a steel coil spring 86 can be placed around a pivot screw 90, which is located on the pivot axis 30 (See FIG. 2). The pivot screw 90, which is preferably made of stainless steel, passes through a hole formed in a second tool component 26. A predetermined clearance is formed between the pivot screw 90 and the second tool component 26 to permit pivotal movement of the second tool component 26 with respect to the pivot screw 90. The distal end of the pivot screw 90 is threaded to a threaded hole formed in a first tool component 22. The pivot screw 90 defines the pivot joint 18 such that the tool components 22, 26 can freely pivot with respect to one another about the pivot axis 30. The coil spring 86 has a first leg 94 and a second leg 98. The first leg 94 is located within a groove 102 formed in the first tool component 22, and the second leg 98 is located within a groove 106 formed in the second tool component 26. The grooves 102, 106 face one another as shown and are substantially hidden when the tool components 22, 26 are assembled. The coil spring 86 is constructed and arranged such that the first leg 94 of the coil spring 86 biases the first tool component 22 in a direction that is opposite to that in which the second leg 98 biases the second tool component 26. Although the coil spring 86 is employed as the spring device in the embodiment of FIGS. 1-6, any of several known spring devices for urging tool handles apart from one another can optionally be employed. For example, a leaf spring that is fixed to one of the tool components 22, 26 such that it engages the other of the tool components 22, 26 can be used instead of the coil spring 86. Also, a coil spring can be employed that is located on the outside of the tool components 22, 26 and not hidden.

The retainer 34 retains the tool components 22, 26 in a storage position. The retainer 34 includes retention members 110, 114, which limit movement of the handles 66, 70 away from one another. The retainer 34 is preferably a unitary plastic part with which at least the retention members 110, 114 are integral. The retainer 34 is preferably molded from the same plastic material described above as the preferred material of the handles 66, 70 or similar material. The retention members 110, 114, or retention means, can be located in places other than those shown as long as the retention members 110, 114 are located to apply inward, opposed forces to the handles 66, 70 to limit their movement in the outward direction.

The retention members 110, 114 form lateral portions of the retainer 34. The retention members 110, 114 are located to face the outer surfaces of the handles 66, 70. The retention members 110, 114 engage corresponding retention surfaces 118, 122 of the handles 66, 70, such that the retention members 110, 114 limit movement of the handles 66, 70 away from one another when the retention members 110, 114 are engaged with the retention surfaces 118, 122 and the apparatus 10a is in the storage position.

In the first embodiment of FIGS. 1-6, as shown in FIGS. 3 and 5, at least sections 126, 130 of the retention members 110, 114 can be inclined with respect to the longitudinal axis 42 of the retainer 42 such that a tapered space 134 is defined between the retention members 110, 114. The inclined sections 126, 130 of the retention members 110, 114 engage the retention surfaces 118, 122 and cause the handles 66, 70 to move toward one another as the retainer 34 moves toward the hand tool 14 when the retainer 34 is being fitted to the hand tool 14. Although FIG. 3 shows slight gaps between retention surfaces 118, 122 of the handles 66, 70 and the corresponding retention members 110, 114, if the spring 86 is installed, the retention members 110, 114 are normally in contact with the retention surfaces 118, 122 when the apparatus 10a is in the storage position of FIG. 3 due to the spring forces. In the embodiment of FIGS. 1-6, each of the retention members 110, 114 is a mirror image of the other, and the retention members 110, 114 are symmetrically located about a central plane of the retainer 34. The retainer 34 is preferably a unitary member of which the retention members 110, 114 are integral parts.

Referring to FIG. 5, the retainer 34 includes a proximal section 138 and a distal section 142. The distal section 142 houses the handles 66, 70 when the hand tool and retainer apparatus 10a is in the storage position. Thus, the proximal section 138 of the retainer 34 includes a hanger tab, which includes an opening 146 for receiving a support member. In the illustrated embodiments of FIGS. 1, 7 and 11, the support member is the key ring 62.

At least a first one of the handles 66 includes a latch member 150 for securing the retainer 34 to the hand tool 14. The latch member 150 is attached to the first handle 66 by a spring element 158 so that the latch member 150 is movable generally in inward and outward directions with respect to a central longitudinal axis 38 of the hand tool 14. In other words, the latch member 150 is supported by a spring element 158.

In the illustrated embodiment of FIG. 1-6, the latch member 150 is a first latch member of a pair of first and second latch members 150, 154, which are oppositely arranged. The second latch member 154 is attached to the second handle 70 by a second spring element 162. The first and second latch members 150, 150 are arranged in a symmetric fashion about a central plane of the hand tool 14. In the embodiment of FIGS. 1-6, each latch member 150, 154 and the corresponding spring element 158, 162 form a cantilever beam.

The retainer 34 includes a socket 166 that receives the latch member 150 when the retainer 34 is fitted to the hand tool 14. The socket 166 includes an end opening 182 formed at the distal end of the socket 166. The end opening 182 is constructed to receive at least a proximal end of the first handle 66 and the latch member 150 when the retainer 34 is fitted to the hand tool 14 to retain the hand tool 14 in the storage position. Generally, the socket 166 houses a proximal portion of the hand tool 14 and exposes a distal portion of the hand tool 14 when the hand tool is retained in the storage position, as shown for example in FIGS. 1-3. The socket 166 includes an engagement surface 174, which is formed by a surface of the socket 166 in a location that corresponds to the latch member 150 when the hand tool 14 is retained in the storage position by the retainer 34. The retainer 34 and the handles 66, 70 are constructed as separate parts such that upon the separation of the retainer 34 from the hand tool 14, the hand tool 14 is free from the retainer 34 when the hand tool 14 is performing a tool function.

The latch member 150 is biased by the spring element 158 toward the engagement surface 174 to lock the hand tool 14 to the retainer 34 when the hand tool 14 is retained in the storage position. The latch member 150 includes a button portion 190, which is an integral part of the latch member 150 and is exposed through an opening 198 in the socket 166 when the hand tool 14 is retained in the storage position. The engagement surface 174 is preferably located on an edge of the opening 198. A cam surface 206 is formed by an interior surface of the socket 166, and the cam surface 206 is positioned to engage the latch member 150 and apply an inwardly directed force to the latch member 150 to deflect the latch member 150 in an inward direction of the hand tool 14 when the retainer 34 is being fitted to the hand tool 14. The cam surface 206 is located generally at a distal end of the socket 166 to engage the button portion 190 and to guide the button portion 190 to the opening 198 when the retainer 34 is fitted to the hand tool 14.

In the illustrated embodiment of FIGS. 1-6, the socket 166 accommodates at least proximal ends of the handles 66, 70 when the hand tool 14 is retained in the storage position, the button portion 190 is a first button portion of a pair of first and second button portions 190, 194, the opening 198 is a first opening 198 of a pair of first and second openings 198, 202, and the second latch member 154 includes the second button portion 194, which is exposed through the second opening 202. The first and second openings 198, 202 are oppositely and symmetrically arranged. Also, in the illustrated embodiment of FIGS. 1-6, the cam surface 206 is a first cam surface 206 of a pair of oppositely and symmetrically arranged first and second cam surfaces 206, 210, which engage the latch members 150, 154, respectively, and the engagement surface 174 is a first engagement surface 174 of a pair of first and second engagement surfaces 174, 178 that are oppositely and symmetrically arranged. The engagement surfaces 174, 178 are preferably located on respective edges of the openings 198, 202.

When the hand tool 14 is retained in the storage position, the button portion 190 is located such that manual depression of the button portion 190 by the user in an inward direction of the hand tool 14 causes the latch member 150 to separate from the engagement surface 174, which allows the hand tool 14 to be manually separated from the retainer 34 from the distal end 54 of the retainer 34. Separation of the hand tool 14 from the retainer 34 allows the handles 66, 70 to pivot away from one another. In the embodiment of FIGS. 1-6, both button portions 190, 194 are pressed simultaneously to release the hand tool 14 from the retainer 34.

The latch member 150 includes a hooking surface 214 that is adapted to engage the engagement surface 174 when the latch member 150 secures the retainer 34 to the hand tool 14, and the hooking surface 214 generally faces toward the end opening 182. In the illustrated embodiment of FIGS. 1-6, the hooking surface 214 is a first hooking surface of a pair of first and second hooking surfaces 214, 218, which are located on the latch members 150, 154, respectively. The hooking surfaces 214, 218, or hooking means, engage the engagement surfaces 174, 178, respectively, to prevent movement of the hand tool 14 in the direction of the distal end of the hand tool 14 when the hand tool 14 is in the storage position.

As shown in FIG. 4, the hooking surface 214, 218 preferably includes an inclined part 222 such that the inclined part 222 of the hooking surface 214 is located to face an outer part, or lateral part, of the engagement surface 174 when the latch member 150 locks the retainer 34 to the hand tool 14. With this arrangement, incidental contact with the button portion 190, 194 will not release the latch member 150. That is, engagement between the inclined part 222 of the hooking surface 214 and the engagement surface 174 will apply force to the hand tool 14 in the proximal direction of the retainer 34 when the button portion 190 is depressed. This makes the retainer 34 more secure by creating slight resistance when the button portion 190 is depressed.

In the embodiment of FIGS. 1-6, the inclined part 222 is a first one of a pair of first and second inclined parts 222, 226 that are located respectively on the latch members 150, 154. The second inclined part operates like the first inclined part 222 to create resistance when the second button 194 is depressed.

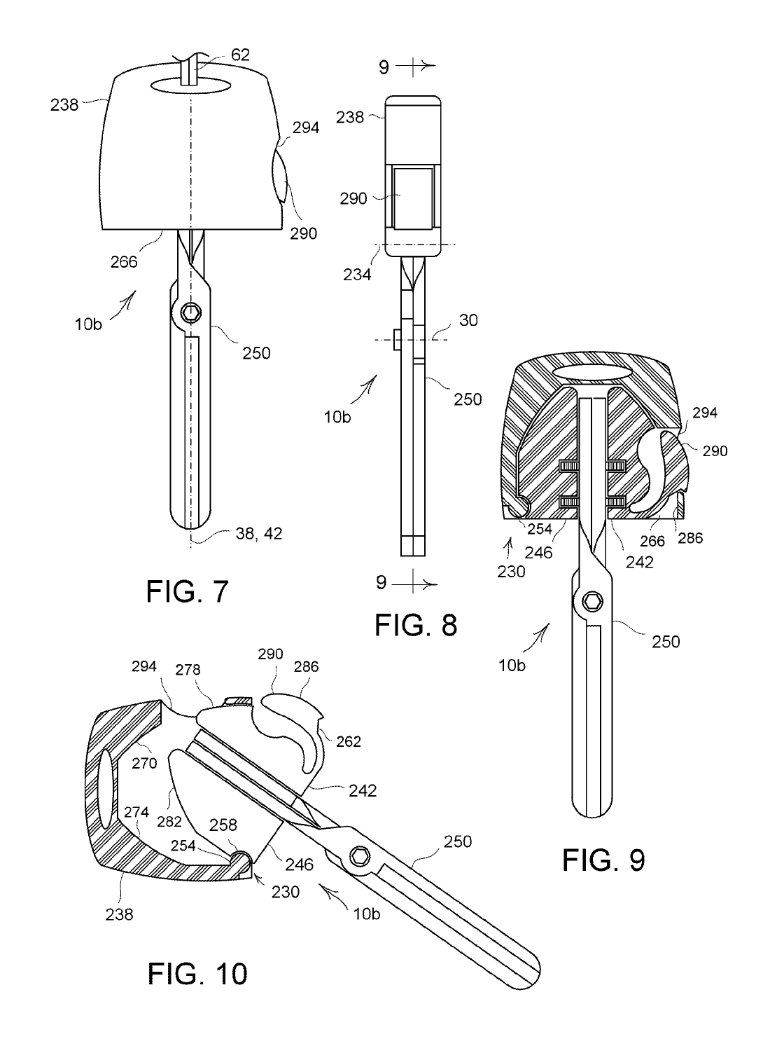

FIGS. 7-10 show an apparatus 10b of a second embodiment of the invention. The apparatus 10b of the second embodiment is similar to that of the first embodiment except as described below. In the description of the second and subsequent embodiments, reference numbers that are the same or similar to the reference numbers used in the description of the first embodiment may be used to designate parts that are the same as or similar to corresponding parts of the first embodiment. Further, parts that are the same as or similar to corresponding parts of the first embodiment may not be described to avoid redundancy.

In the apparatus 10b of the second embodiment, a retainer 238 retains a first handle 242 and a second handle 246 of a hand tool 250. As in the apparatus 10a of the first embodiment, a spring device 82 can be employed to urge the handles 242, 246 away from one another. Unlike the apparatus 10a of the first embodiment, a pivotal coupler 230 is formed by the retainer 238 and the second handle 246, so that the retainer 238 is pivotal with respect to the second handle 246 about a pivot axis 234, as shown in FIGS. 7-10. The retainer 238 of the second embodiment includes a convex coupler part 254, which forms part of the pivotal coupler 230. A concave coupler part 258, which forms another part of the pivotal coupler 230, is formed in the second handle 246. The pivotal coupler permits the hand tool 250 to pivot with respect to the retainer 238 as shown in FIG. 10. The pivotal coupler 230 permits the hand tool 250 to easily separate from the retainer 238 when the hand tool 250 is pivoted out of the storage position, for example, in the position shown in FIG. 10. However, the pivotal coupler 230 resists separation of the hand tool 250 from the retainer when the hand tool 250 is in the storage position of FIG. 9. The parts of the pivotal coupler 230 can be reversed; that is, the concave coupler part 258 can be formed on the retainer 238, and the convex coupler part can be formed on the second handle 246.

In the second embodiment of FIGS. 7-10, the hand tool 250 has only one latch member 262, which is accommodated in a socket 266 formed by the retainer 238. A first retention member 270 and a second retention member 274 are formed in the socket 262. Like the apparatus 10 of the first embodiment, the first retention member 270 contacts a first retention surface 278 of the first handle 242 and the second retention member 274 contacts a second retention surface 282 of the second handle 246 to limit movement of the handles 242, 246 when the apparatus 10b is in the storage position.

When the handles 242, 246 are placed in the storage position, the handles 242, 246 are inserted into the socket 266 in a pivotal motion. First, the pivotal coupler 230 is coupled, as shown in FIG. 10. Then, the hand tool 250 is pivoted in the counterclockwise direction of FIG. 10 with respect to the retainer 238. The latch member 262 engages a cam surface 286, which is formed at a distal end of the socket 266 in a location corresponding to the latch member 246, when the latch member 246 enters the socket 266. A button portion 290 of the latch member 262 enters an opening 294 to lock the retainer 238 to the hand tool 250, as shown in FIG. 9, in a manner similar to the operation of the first embodiment. From the storage position, the hand tool 250 is released from the retainer 238 by depressing the button portion 290, which is exposed from the retainer 238, and by pivoting the hand tool 250 in the clockwise direction of FIG. 10 with respect to the retainer 238.

In the illustrated embodiment of FIGS. 7-10, it may be necessary to depress the button portion 290 when placing the hand tool 250 in the storage position. However, the latch member 262 can be located such that the latch member 262 is engaged and depressed by the cam surface 286 when the latch member 262 enters the socket 266 without any need for the user to depress the button portion 290 when placing the hand tool 250 into the storage position.

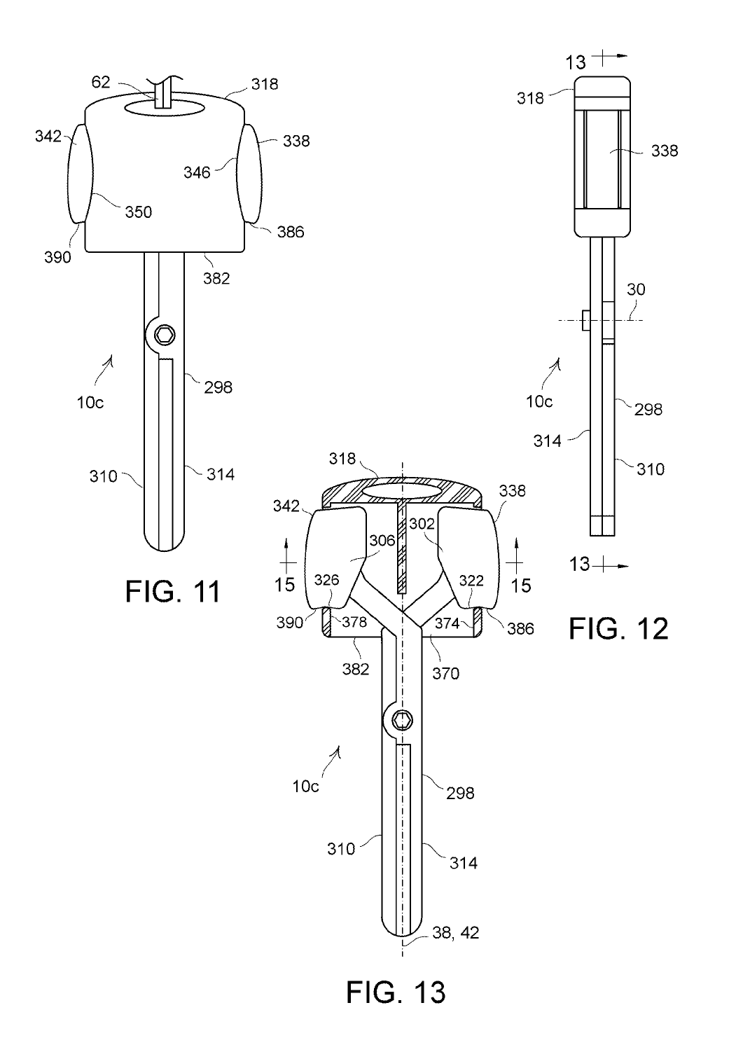

FIGS. 11-15 show an apparatus 10c of a third embodiment of the invention. The apparatus 10c includes a retainer 318 and a hand tool 298. In this embodiment, first and second handles 302, 306 are formed on the proximal ends of first and second tool components 310, 314 of the hand tool 298, respectively. In the illustrated embodiment, the handles 302, 306 are molded to the tool components 310, 314 of the hand tool 298, respectively. However, the handles 302, 306 can be fastened to the tool components 310, 314 by screws or other known fasteners.

The handles 302, 306 are fitted inside the retainer 318 when the apparatus 10c is in the storage position, as shown in FIG. 13. The handles 302, 306 and the retainer 318 are preferably made of molded synthetic resin like the material described above for forming the handles 66, 70 and the retainer 34 of the apparatus 10a of the first embodiment.

The first and second handles 302, 306 include first and second latch members 322, 326. The apparatus 10c of the third embodiment does not include a spring element between the latch member 322, 326 and a body of the handle 302, 306. Thus, in this embodiment, the latch members 322, 326 do not move independently of the handles 302, 306. Therefore, in the apparatus 10c of the third embodiment, a spring device 82 may be connected to the tool components 310, 314 for applying spring forces to the tool components 310, 314 such that the handles are urged in opposite directions, away from one another, about the pivot axis 30, as illustrated in FIG. 6. Otherwise, a spring device (not illustrated) can be located inside the retainer to apply outward forces to the handles 302, 306. If the spring device is located inside the retainer 318 and not on the hand tool 298, the handles 302, 306 must be manipulated in both opening and closing directions during use.

In the third embodiment, when the hand tool 298 is in the storage position, button portions 338, 342 of the handles 302, 306 are exposed from the retainer 318, as shown in FIG. 11. The hand tool 298 can be removed from the retainer 318 by depressing the button portions 338, 342 simultaneously and manually pulling the hand tool 298 from the retainer 318 in the distal direction of the hand tool 298.

The retainer 318 includes first and second button openings 346, 350 located at opposite lateral sides of the retainer 318. The retainer 318 further includes first and second retention members 354, 358, and the handles 302, 306 include first and second retention surfaces 362, 366. When the hand tool 298 is placed in the storage position, if the spring device 86 is employed, the retention surfaces 362, 366 engage the retention members 354, 358 under the force of the spring device 82 to limit outward movement of the handles 302, 306. If the spring device 86 is not employed, a spring device (not illustrated) can be located inside the retainer 318 to urge the handles 302, 306 in an outward direction. Although a slight gap may appear between the retention surfaces 346, 350 and the retention members 354, 358 in FIG. 13, the retention surfaces 346, 350 normally engage the retention members 354, 358 as a result of the spring forces of the spring device 82 or other spring device located inside the retainer 318, when the hand tool 298 is in the storage position of FIG. 13. The proximal end surfaces of the handles 302, 306 are inclined as shown in FIG. 13 such that inward depression of the button portions 338, 342 causes separation between the retention members 354, 358 and the corresponding retention surfaces 346, 350.

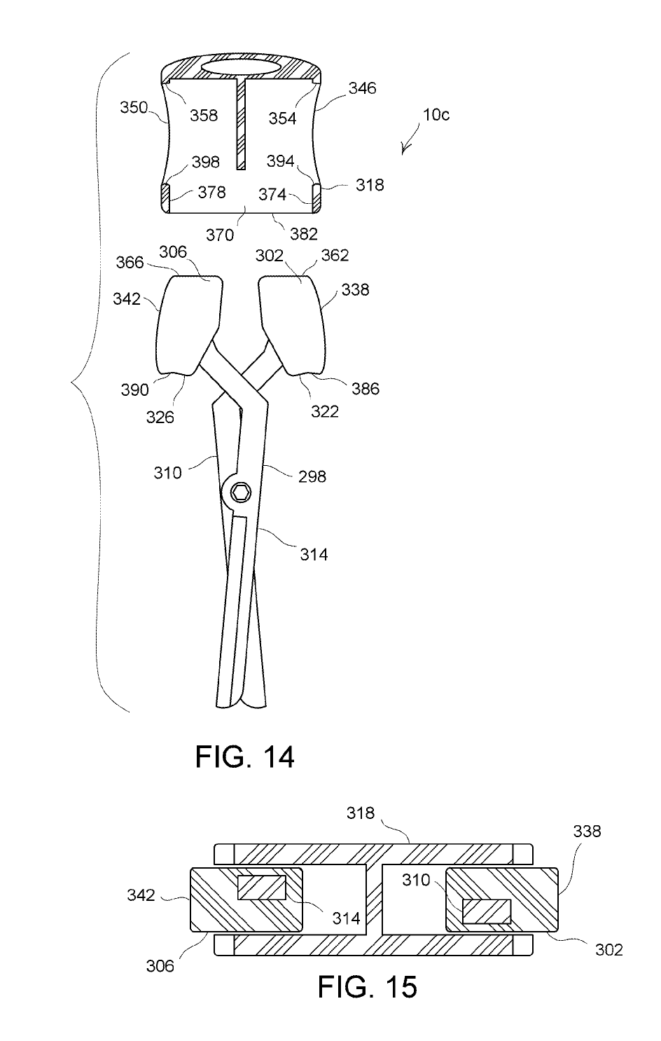

In the apparatus 10c of the third embodiment, the retainer includes a socket 370. A first cam surface 374 and a second cam surface 378 are formed on opposite inner surfaces of the socket 370 at a distal section of the socket 370. When the hand tool 298 is placed into the storage position of FIGS. 11-13, the handles 302, 306 are manually moved toward one another as shown in FIG. 14. Then, the handles 302, 306 are inserted into an end opening 382 of the socket 354 such that the cam surfaces 374, 378 engage outer surfaces of the respective button portions 338, 342. The handles 302, 306 are further fitted into the socket 370 until the button portions 338, 342 enter the respective button openings 346, 350.

Although not illustrated, the handles 302, 306 of the third embodiment can include finger openings for allowing a user to more easily open and close the hand tool 298.

When the hand tool 298 is in the storage position, the hand tool 298 is prevented from escaping from the retainer 318 by first and second hooking surfaces 386, 390 which are formed on distal end surfaces of the first and second latch members 322, 326, respectively, and which generally face toward the end opening 382. The hooking surfaces 386, 390 engage first and second engagement surfaces 394, 398, which are formed at respective edges of the button openings 346, 350. As in the previous embodiments, the hooking surfaces 386, 390 secure the hand tool 298 in the retainer 318 until the button portions 338, 342 are depressed.

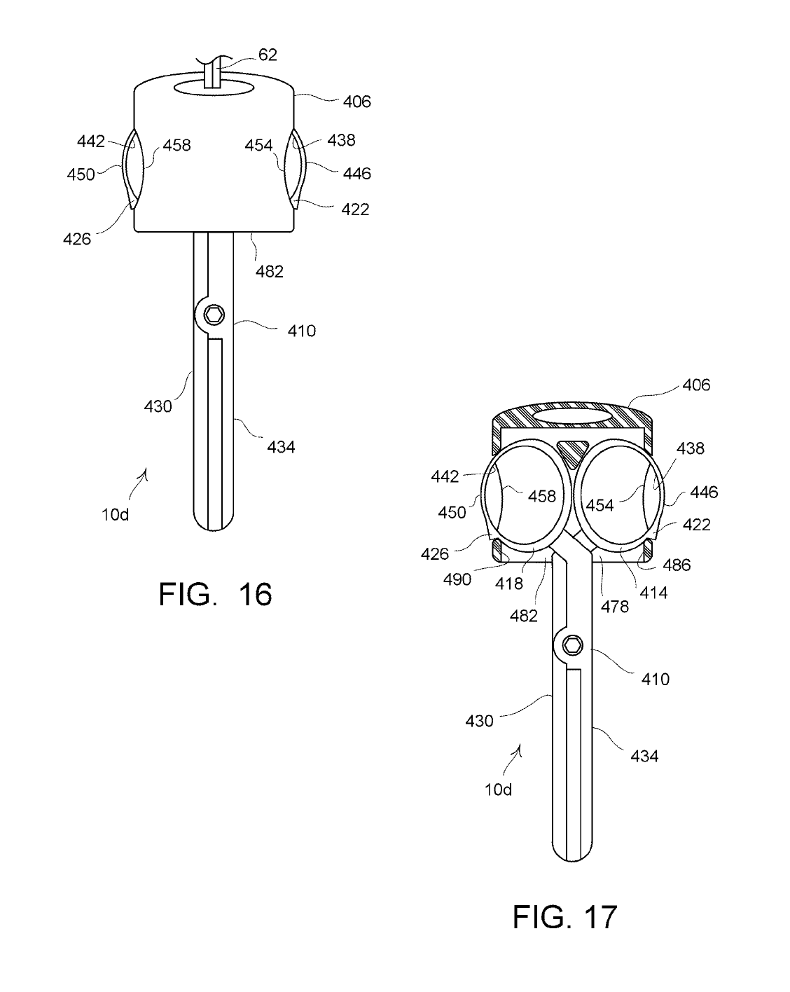

FIGS. 16-19 show an apparatus 10d of a fourth embodiment of the invention. The apparatus 10d includes a retainer 406 and a hand tool 410. In this embodiment, first and second handles 414, 418 are formed on the proximal ends of first and second tool components 422, 426 of the hand tool 410, respectively. The handles 414, 418 are fitted inside the retainer 318 when the apparatus 10d is in the storage position, as shown in FIGS. 16 and 17. The retainer 406 is preferably made of molded synthetic resin like the material described above for forming the retainer 34 of the apparatus 10a of the first embodiment.

The first and second handles 414, 418 include first and second latch members 422, 426. In this embodiment, the latch members 422, 426 can move independently as a result of the flexibility of the handles 414, 418. More specifically, at least outer parts of the handles 414, 418, at which the latches members 422, 426 are formed, are flexible and spring-like and return to their original shape after being deformed. The handles 414, 418 are preferably made of flexible plastic or plastic-coated metal core members. Thus, the latch members 422, 426 of the fourth embodiment function in a manner much like the latch members 150, 154 of the first embodiment. That is, the latch members 422, 426 are spring-biased.

In the apparatus 10d of the fourth embodiment, first and second finger openings 438, 442 are formed in the handles 414, 418, which allow the handles 414, 418 to be more easily manipulated in both opening and closing directions during use. Further, since finger openings 438, 442 are provided, there is no need for a spring device to urge the handles 414, 418 apart.

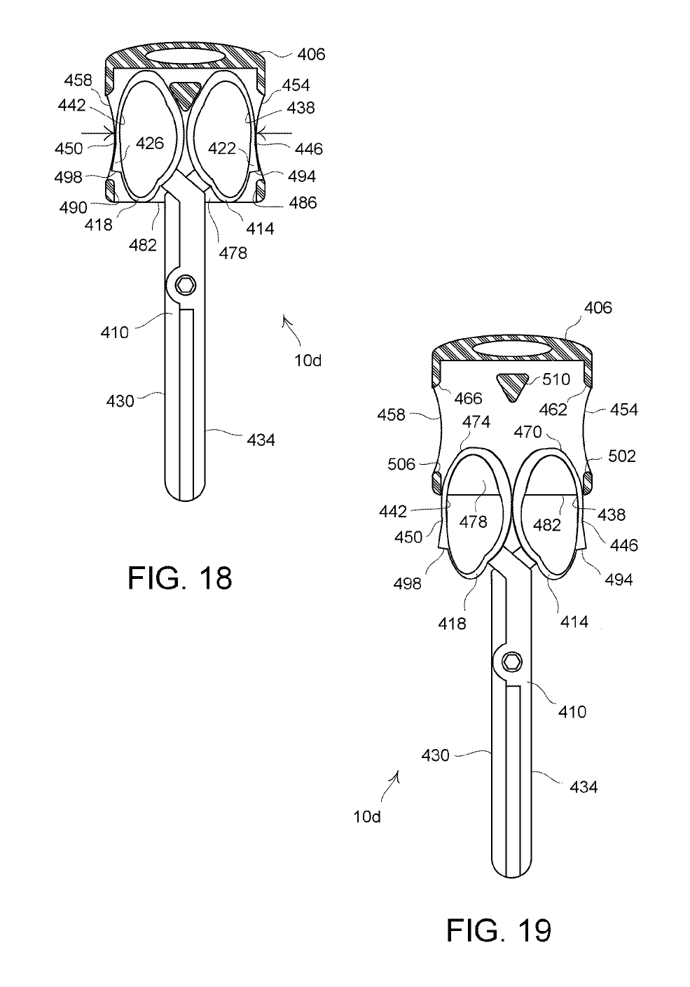

In the fourth embodiment, when the hand tool 410 is in the storage position, button portions 446, 450 of the handles 414, 418 are exposed from the retainer 406, as shown in FIG. 16. The hand tool 410 can be removed from the retainer 406 by depressing the button portions 446, 450 simultaneously and manually pulling the hand tool 410 from the retainer 406 in the distal direction of the hand tool 410. FIG. 18 illustrates a state in which the button portions 446, 450 are depressed in preparation for removing the hand tool 410 from the retainer 406. The unnumbered arrows in FIG. 18 represent the application of forces by a user's thumb and forefinger.

The retainer 406 includes first and second button openings 454, 458 located at opposite lateral sides of the retainer 406. The retainer 406 further includes first and second retention members 462, 466, and the handles 414, 418 include first and second retention surfaces 470, 474. When the hand tool 410 is in the storage position, the retention surfaces 470, 474 engage the retention members 462, 466 to limit outward movement of the handles 414, 418. That is, the retention surfaces 470, 474 normally engage the retention members 462, 466 as a result of the predetermined dimensions of the retainer 406 and the hand tool 410 when the hand tool 410 is in the storage position of FIG. 17.

In the apparatus 10d of the fourth embodiment, the retainer 406 includes a socket 478. A first cam surface 486 and a second cam surface 490 are formed on opposite inner surfaces of the socket 478 at a distal section of the socket 478. When the hand tool 410 is placed into the storage position of FIGS. 16 and 17, the handles 414, 418 are moved into abutment with one another. Then, the handles 414, 418 are squeezed together, as shown in FIG. 19, and inserted into an end opening 482 of the socket 478 such that the cam surfaces 486, 490 engage outer surfaces of the respective button portions 454, 458. The handles 414, 418 are further fitted into the socket 478 until the button portions 446, 450 enter the respective button openings 454, 458.

When the hand tool 410 is in the storage position, the hand tool 410 is prevented from escaping from the retainer 406 by first and second hooking surfaces 494, 498, which are formed on respective distal end surfaces of the first and second latch members 422, 426, and which generally face toward the end opening 482. The hooking surfaces 494, 498 engage first and second engagement surfaces 502, 506, which are formed at respective edges of the button openings 454, 458. As in the previous embodiments, the hooking surfaces 494, 498 secure the hand tool 410 in the retainer 406 until the button portions 450, 454 are depressed.

The retainer 406 of the fourth embodiment can further include a wedge-shaped abutment 510, which is located between the handles 414, 418 when the hand tool 410 is in the storage position, as shown in FIG. 17. The abutment 510 reinforces the retainer 406 and stabilizes the hand tool 410 in the storage position.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A hand tool and retainer apparatus comprising:
a hand tool having a pivot joint and a pair of tool components that pivot about a pivot axis of the pivot joint, wherein each tool component has a distal end and a proximal end, the pivot joint is located between the proximal end and the distal end of each tool component, and handles are located respectively at the proximal ends of the tool components;
a retainer that retains the handles in a storage position, wherein the retainer includes retention members that limit movement of the handles away from one another, wherein
the retainer is manually fitted to the hand tool when a user places the hand tool in the storage position,
at least a first one of the handles includes a latch member for securing the retainer to the hand tool,
the retainer includes a socket that receives the latch member when the retainer is fitted to the hand tool,
the socket includes an engagement surface, which is formed by a surface of the socket in a location that corresponds to the latch member when the hand tool is retained in the storage position by the retainer,
the latch member locks the hand tool to the retainer when the hand tool is retained in the storage position by the retainer,
the latch member includes a button portion, which is an integral part of the latch member and is exposed through an opening in the socket when the hand tool is retained in the storage position by the retainer,
a cam surface is formed by an interior surface of the socket, and the cam surface is positioned to engage the latch member and apply an inwardly directed force to the latch member to deflect the latch member in an inward direction of the hand tool when the retainer is being fitted to the hand tool,
when the hand tool is retained in the storage position, the button portion is located such that manual depression of the button portion by the user in an inward direction of the hand tool causes the latch member to separate from the engagement surface, which allows the hand tool to be manually separated from the retainer from a distal end of the retainer, and wherein separation of the hand tool from the retainer allows the handles to pivot away from one another.

2. The apparatus of claim 1, wherein the latch member is supported by a spring element so that the latch member is movable generally in inward and outward directions with respect to a central axis of the hand tool, and the latch member is biased by the spring element toward the engagement surface when the hand tool is retained in the storage position by the retainer.

3. The apparatus of claim 1, wherein the retainer is a unitary member of which the retention members are integral parts.

4. The apparatus of claim 1, wherein the cam surface is located generally at a distal end of the socket to engage the button portion and to guide the button portion to the opening when the retainer is fitted to the hand tool.

5. The apparatus of claim 1, wherein the hand tool and the retainer are constructed as separate parts such that upon the separation of the retainer from the hand tool, the hand tool is free from the retainer.

6. The apparatus of claim 1, wherein an end opening is formed at the distal end of the socket, and the end opening is constructed to receive at least the first handle and the latch member when the retainer is fitted to the hand tool to retain the hand tool in the storage position.

7. The apparatus of claim 5, wherein the latch member includes a hooking surface that is adapted to engage the engagement surface when the latch member secures the retainer to the hand tool, and wherein the hooking surface generally faces toward the distal end of a corresponding tool component.

8. The apparatus of claim 2, wherein the latch member and the spring element form a cantilever beam.

9. The apparatus of claim 1, wherein the hand tool is a pair of scissors.

10. The apparatus of claim 1, wherein the engagement surface is located on an edge of the opening.

11. The apparatus of claim 1, wherein the latch member is a first latch member of a pair of opposite latch members on the hand tool, the engagement surface is a first engagement surface of a pair of opposite engagement surfaces on the retainer, and the opening is a first opening of a pair of opposite openings in the retainer.

12. The apparatus of claim 1, wherein a pivot joint is formed by the retainer and a second one of the handles, so that the hand tool is pivotal with respect to the retainer.

13. The apparatus of claim 1, wherein the handles have opposed abutment surfaces that limit the movement of the handles toward one another, and the abutment surfaces contact one another when the tool is retained in the storage position.

14. The apparatus of claim 1, wherein at least sections of the retention members are inclined with respect to a longitudinal axis of the retainer such that a tapered space is defined between the retention members.

15. The apparatus of claim 1, wherein the socket accommodates at least proximal ends of the handles when the hand tool is retained in the storage position.

16. The apparatus of claim 1, wherein the socket houses a proximal portion of the hand tool and exposes a distal portion of the hand tool when the hand tool is retained in the storage position.

17. The apparatus of claim 1, wherein a proximal section of the retainer includes a hanger tab, which includes an opening for receiving a support member.

18. The apparatus of claim 1, wherein the retainer is a unitary plastic part.

19. The apparatus of claim 1, wherein a spring device is connected to the tool components for applying spring forces to the tool components such that the handles are urged in opposite directions, away from one another, about the pivot axis.

20. The apparatus of claim 19, wherein the latch member is biased toward the engagement surface at least by the spring device.
